(19) United States
(12) Patent Application Publication
(10) Pub. No.: US 2021/0159521 A1
(43) Pub. Date: May 27, 2021

(54) PROCESS OF CONVERTING SEAWATER TO HYDROGEN, PIPING IT AND REFORMING IT TO FRESHWATER

(71) Applicant: Raymond Payette, Quebec (CA)

(72) Inventor: Raymond Payette, Quebec (CA)

(21) Appl. No.: 16/696,809

(22) Filed: Nov. 26, 2019

(51) Int. Cl. H01M 8/04119; H01M 8/0656; H01M 8/04082; C25B 1/00; C25B 1/10; C25B 9/08; C25B 11/03; C25B 11/04

(52) U.S. Cl. CPC H01M 8/04156; H01M 8/04126; H01M 8/0656; H01M 8/04216; C25B 1/003; H01M 2250/10; C25B 9/08; C25B 11/035; C25B 11/0415; C25B 11/0447; C25B 1/10

(57) ABSTRACT

A process that converts water into hydrogen, transports it and then reforms it into freshwater to irrigate land.

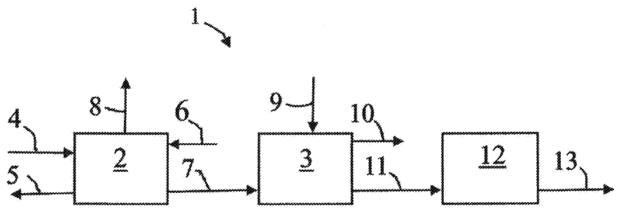

### CROSS REFERENCES TO RELATED APPLICATIONS

Please, refer back to provisional patent No. 62/817,569 having the filing date of Mar. 13, 2019.

### SPECIFICATION

### Background of the Invention

The present invention is in the technical field of treatment of water. More particularly, the present invention is in the technical field of treatment of water by electrochemical methods.

There is a need to transform seawater into freshwater and to transport it economically to a remote location to irrigate land.

### SUMMARY OF THE INVENTION

The present invention is a process that intakes water, extracts hydrogen gas from it, pipes away the hydrogen, and then reforms it to freshwater.

Water comprises seawater and freshwater.

Transport of water is costly and requires much energy. The present invention extracts hydrogen gas from water using electrical energy, pipes it either as a gas or its liquid form, across a long distance and at different altitudes, and then reforms it to freshwater while producing electrical energy. This is economical since transporting hydrogen is cheaper than transporting water and since some of the electrical energy expended is recuperated.

Presently hydrogen is used for the production of electrical energy by electrical vehicles with freshwater as waste. The present invention is an unexpected combination that uses an electrochemical technology to process seawater so that it can be transported economically as hydrogen and then produce freshwater with a similar electrochemical technology while recuperating electrical energy.

Presently 95% of hydrogen gas is produced from natural gas along with a by-product, carbon dioxide that is a greenhouse gas.

Presently, tube trailers, container trailers, or liquid trailers transport hydrogen fuel. Shell® stated “For the transport of very large volumes of hydrogen, a comprehensive pipeline network is ideal.”

The object of this invention is to produce hydrogen from water, pipe it inland and reform it into freshwater for irrigation purpose; it can also be used for domestic or industrial purposes.

Freshwater is stored at the end of the process.

Excess energy in the power grid could be stored as freshwater.

### BRIEF DESCRIPTION OF THE DRAWING

The drawing is a flow-diagram of steps of a process of the present invention.

### DETAILED DESCRIPTION OF THE INVENTION

Referring now to the invention in more detail, wherein the steps of a process of the present invention are shown in a flow-diagram 1, the process begins with a water input 4 into a electrolysis apparatus 2, that inputs electrical energy 6, outputs a seawater concentrate 5 discharged at sea, outputs oxygen 8 in the air, and outputs hydrogen into a pipeline 7 to transport it to a remote location and reforms it by a water-reforming apparatus 3 that inputs oxygen 9 from the air, outputs electrical energy 10 and outputs freshwater that is transported by means of a pipeline 11 into a container 12 and outputs it onto 13 land.

In more detail, still referring to the invention, the electrolysis apparatus 2, consists of an electrolyzer running as a fuel cell, a photoelectrolysis system, a photobiological system, an alkaline electrolysis system, a solid oxide fuel cell, or a proton-exchange membrane electrolysis. A preferred embodiment is to transform seawater by electrolysis with a hierarchical anode nickel-iron hydroxide electro-catalyst layer coated on a sulfide layer formed on a porous nickel substrate foam.

In more detail, still referring to the invention, the seawater 4 is freshwater.

In more detail, still referring to the invention, the seawater concentrate 5 is discharged in a salt evaporation pond.

In more detail, still referring to the invention, the water-reforming apparatus 3, consists of a proton-exchange membrane fuel cell.

In more detail, still referring to the invention, the electrolysis apparatus 2 and the water-reforming apparatus 3 include a gas humidifier subsystem.

In more detail, still referring to the invention, the amount of electrical energy 6 and of water 4 are in sufficient proportion to produce the hydrogen fed into the pipeline 7.

In more detail, still referring to the invention, the electrolysis apparatus 2 compresses and cools the hydrogen according the well-known phase graph having a triple point at 21.2° K and the critical point at 32° K.

In more detail, still referring to the invention, the pipeline 7 consists of sections having different diameters, depending on the distance covered, the height raised or lowered and the environing conditions.

In more detail, still referring to the invention, the pipeline 7 is made of metal, polymeric composites, polymeric nanocomposites, fiber-reinforced polymers, or engineered plastics.

In more detail, still referring to the invention, the freshwater transferred 11 is cooled to convert steam to liquid freshwater.

In more detail, still referring to the invention, the freshwater stored in a container 12 is used for ends other than irrigation, such as domestic consumption that is another preferred embodiment or industrial ends.

In more detail, still referring to the invention, the container 12 consists of a tank or a lake.

The advantages of the present invention include, without limitation, an efficient and economical means of transforming water into hydrogen, of transporting it at a lesser cost than water over long distances and higher ground level, and reforming it into freshwater.

In broad embodiment, the present invention is a means to convert water to hydrogen, to transport it to a remote location and to reform it to freshwater to irrigate land.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1- A system for convening seawater into freshwater, comprising
an electrolysis apparatus capable of converting seawater into hydrogen and oxygen and comprising a hierarchical anode nickel-iron hydroxide electrocatalyst laver coated on a sulfide laver formed on a porous nickel substrate foam, said oxygen being released in the air;
a conduit capable of evacuating a seawater concentrate into a sea;
a first pipeline capable of transporting the hydrogen from the electrolysis apparatus to a remote location;
a fuel cell capable of reforming oxygen from the air and the hydrogen into freshwater and of producing electrical energy, said electrical energy being fed in the electrical grid distribution system;
a second pipeline capable of transporting freshwater from the fuel cell to a container capable of storing freshwater,
and the container.

2- The process of claim 1 wherein the water inputted from the original location is seawater and a concentrate of seawater is fed back into the sea.

3- The process of claim 1 wherein the water inputted from the original location is seawater and a concentrate of seawater is fed in an evaporation pond.

4- The process of claim 1 wherein the electrolysis apparatus is comprised of a proton-exchange membrane electrolysis apparatus.

5- The process of claim 1 wherein the fuel cell is comprised of a proton-exchange membrane fuel cell.

6- The process of claim 1 wherein the electrolysis apparatus is comprised of an alkaline electrolysis apparatus.

7- The process of claim 1 wherein the electrolysis apparatus is comprised of an electrolyzer running as a fuel cell apparatus.

8- The process of claim 1 wherein the electrolysis apparatus is comprised of a solid oxide fuel cell apparatus.

9- The process of claim 1 wherein the electrolysis apparatus is comprised of a photoelectrolysis apparatus.

10- The process of claim 1 wherein the electrolysis apparatus is comprised of a photobiological apparatus.

11- The process of claim 1 wherein the electrolysis apparatus is comprised of a hierarchical anode nickel-iron hydroxide electrocatalyst layer coated on a sulfide layer formed on a porous nickel substrate foam.

12- The process of claim 4 wherein the proton-exchange membrane electrolysis apparatus includes a gas humidifier subsystem.

13- The process of claim 5 wherein the fuel cell includes a gas humidifier subsystem.

14- The process of claim 1 wherein the pipeline is made of metal.

15- The process of claim 1 wherein the pipeline is made of polymeric composites.

16- The process of claim 1 wherein the pipeline is made of polymeric nanocomposites.

17- The process of claim 1 wherein the pipeline is made of fiber-reinforced polymers.

18- The process of claim 1 wherein the pipeline is made of engineered plastics.

19- The process of claim 1 wherein the freshwater is used for irrigation purposes.

20- The process of claim 1 wherein the freshwater is used for domestic purposes.

21- The process of claim 1 wherein the freshwater is used for industrial purposes.

22- The process of claim 1 wherein the container is a tank or a reservoir.

23- The process of claim 1 wherein the container is a lake, a canal or a river.

24- A method for converting seawater to freshwater, comprising the steps of
providing a source of seawater,
converting the water to oxen and hydrogen by electrochemical means and comprising a hierarchical anode nickel-iron hydroxide electrocatalyst layer coated on a sulfide layer formed on a porous nickel substrate foam, said oxygen being released in the air;
evacuating a seawater concentrate into a sea by a conduit;
transporting the hydrogen to a remote location with a first pipeline;
reforming oxygen from the air and the hydrogen to freshwater by electrochemical means;
transporting the freshwater to a container with a second pipeline;
storing the freshwater in the container;
generating electrical energy.
